(19) United States
(12) Patent Application Publication
(10) Pub. No.: US 2025/0357487 A1
(43) Pub. Date: Nov. 20, 2025

(54) NEGATIVE ELECTRODE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Jin Seok PARK, Yongin-si (KR); Hyun NAM, Yongin-si (KR); Taeil LEE, Yongin-si (KR); JeongJoo PARK, Yongin-si (KR); Minho LEE, Yongin-si (KR); Kukjoo LEE, Yongin-si (KR)

(73) Assignee: SAMSUNG SDI CO., LTD., Yongin-si (KR)

(21) Appl. No.: 19/019,800

(22) Filed: Jan. 14, 2025

(30) Foreign Application Priority Data
May 14, 2024 (KR) 10-2024-0063432

(51) Int. Cl. H01M 4/62; H01M 4/02; H01M 4/133; H01M 4/36; H01M 4/587; H01M 10/0525

(52) U.S. Cl. CPC H01M 4/622; H01M 4/133; H01M 4/366; H01M 4/587; H01M 10/0525; H01M 2004/027

(57) ABSTRACT

Disclosed are negative electrodes and rechargeable lithium batteries. The negative electrode includes a negative electrode current collector, and a negative electrode active material layer on the negative electrode current collector. The negative electrode active material layer includes a first active material layer, a second active material layer, and a third active material layer that are sequentially stacked on the negative electrode current collector. The second active material layer includes a silicon-containing particle and a conductive binder. The conductive binder includes a unit derived from a first monomer, a unit derived from a second monomer, and a unit derived from a third monomer. Each of the first monomer and the second monomer is a (meth)acrylate monomer. The third monomer is a zwitterionic monomer.

### CROSS-REFERENCE TO RELATED APPLICATION

This U.S. nonprovisional application claims priority under 35 U.S.C. § 119 to Korean Patent Application No. 10-2024-0063432 filed on May 14, 2024 in the Korean Intellectual Property Office, the disclosure of which is hereby incorporated by reference in its entirety.

### BACKGROUND

The present disclosure relates to a negative electrode for a rechargeable lithium battery, and a rechargeable lithium battery including the negative electrode, and more particularly, to a multilayered negative electrode for a rechargeable lithium battery, and a rechargeable lithium battery including the multilayered negative electrode.

With increasing use of battery-using electronic devices, such as, e.g., mobile phones, laptop computers, electric vehicles, and the like, there is increasing demand for rechargeable batteries with high energy density and high capacity.

A rechargeable lithium battery includes a positive electrode, a negative electrode, and an electrolyte, the positive and negative electrodes include an active material in which intercalation and deintercalation are possible, and the rechargeable lithium battery generates electrical energy caused by oxidation and reduction reactions when lithium ions are intercalated and deintercalated.

### SUMMARY

An example embodiment of the present disclosure includes a negative electrode for a rechargeable lithium battery having a large capacity and a high charge-discharge rate.

An example embodiment of the present disclosure includes a rechargeable lithium battery having a large capacity and a high charge-discharge rate.

According to an example embodiment of the present disclosure, a negative electrode for a rechargeable lithium battery may include a negative electrode current collector, and a negative electrode active material layer on the negative electrode current collector. The negative electrode active material layer may include a first active material layer, a second active material layer, and a third active material layer that are stacked, e.g., sequentially stacked, on the negative electrode current collector. The second active material layer may include a silicon-containing particle and a conductive binder. The conductive binder may include a unit derived from a first monomer, a unit derived from a second monomer, and a unit derived from a third monomer. Each, or at least one, of the first monomer and the second monomer may be or include a (meth)acrylate monomer. The third monomer may be or include a zwitterionic monomer.

According to an example embodiment of the present disclosure, a negative electrode for a rechargeable lithium battery may include a negative electrode current collector, and a negative electrode active material layer on the negative electrode current collector. The negative electrode active material layer may include crystalline carbon, a silicon-containing particle, and a conductive binder. The negative electrode active material layer may have a first region adjacent to the negative electrode current collector, a third region adjacent to a top surface of the negative electrode active material layer, and a second region on a center of the negative electrode active material layer. The second region may be vertically interposed between the first region and the third region. An amount of the silicon-containing particle in the second region may be greater than an amount of the silicon-containing particle in the first region. The amount of the silicon-containing particle in the second region may be greater than an amount of the silicon-containing particle in the third region. An amount of the conductive binder in the second region may be greater than an amount of the conductive binder in the first region. The amount of the conductive binder in the second region may be greater than an amount of the conductive binder in the third region.

According to an example embodiment of the present disclosure, a rechargeable lithium battery may include the negative electrode, a positive electrode that includes a positive electrode current collector and a positive electrode active material layer on the positive electrode current collector, and a separator between the negative electrode and the positive electrode.

### BRIEF DESCRIPTION OF DRAWINGS

FIG. 1 illustrates a simplified conceptual diagram showing a rechargeable lithium battery according to an example embodiment of the present disclosure.

FIGS. 2 to 5 illustrate simplified diagrams showing a rechargeable lithium battery according to an example embodiment of the present disclosure.

FIG. 6 illustrates a cross-sectional view showing a rechargeable lithium battery according to an example embodiment of the present disclosure.

FIG. 7 illustrates an enlarged view showing a negative electrode for a rechargeable lithium battery according to an example embodiment of the present disclosure.

FIG. 8 illustrates a cross-sectional view showing a method of manufacturing a negative electrode according to an example embodiment of the present disclosure.

### DETAILED DESCRIPTION

In order to sufficiently understand the configuration and effect of the present disclosure, some example embodiments of the present disclosure will be described with reference to the accompanying drawings. It should be noted, however, that the present disclosure is not limited to the following example embodiments, and may be implemented in various forms. Rather, the example embodiments are provided only to disclose the present disclosure and let those skilled in the art fully know the scope of the present disclosure.

In this description, it will be understood that, when an element is referred to as being “on” another element, the element can be directly on the other element, or intervening elements may be present between therebetween. In the drawings, thicknesses of some components may be exaggerated for effectively explaining the technical contents. Like reference numerals refer to like elements throughout the specification.

Unless otherwise specially noted in this description, the expression of singular form may include the expression of plural form. In addition, unless otherwise specially noted, the phrase “A or B” may indicate “A but not B,” “B but not A,” and “A and B.” The terms “comprises/includes” and/or “comprising/including” used in this description do not exclude the presence or addition of one or more other components.

As used herein, the term “combination thereof” may refer to a mixture, a stack, a composite, a copolymer, an alloy, a blend, or a reaction product.

Unless otherwise especially defined in this description, a particle diameter may be an average particle diameter. In addition, a particle diameter indicates an average particle diameter (D₅₀) where a cumulative volume is about 50 volume % in a particle size distribution. The average particle diameter (D₅₀) may be measured by a method widely known to those skilled in the art, for example, by a particle size analyzer, a transmission electron microscope (TEM) image, or a scanning electron microscope (SEM) image. Alternatively, a dynamic light-scattering measurement device is used to perform a data analysis, the number of particles is counted for each particle size range, and then from this, an average particle diameter (D₅₀) value may be obtained through a calculation. Dissimilarly, a laser scattering method may be utilized to measure the average particle diameter (D₅₀). In the laser scattering method, a target particle is distributed in a dispersion solvent, introduced into a laser scattering particle measurement device (e.g., MT3000 commercially available from Microtrac, Inc), irradiated with ultrasonic waves of 28 kHz at a power of 60 W, and then an average particle diameter (D₅₀) is calculated in the 50% standard of particle diameter distribution in the measurement device.

In this disclosure, the term “substituted or unsubstituted” may refer to substituted or unsubstituted with at least one substituent including at least one of a deuterium atom, a halogen atom, a cyano group, a nitro group, an amine group, a silyl group, an oxy group, a thio group, a sulfinyl group, a sulfonyl group, a carbonyl group, a boron group, a phosphine oxide group, a phosphine sulfide group, an alkyl group, an alkenyl group, an alkoxy group, a hydrocarbon ring group, an aryl group, and a heterocyclic group. In addition, each substituent mentioned above may be substituted or unsubstituted. For example, a biphenyl group may be interpreted as an aryl group or as a phenyl group substituted with a phenyl group.

In this description, the halogen atom may include at least one of fluorine, chlorine, bromine, and iodine atoms.

In this disclosure, an alkyl group may be linear or branched. The number of carbon atoms in the alkyl group may range from 1 to 50, from 1 to 30, from 1 to 10, or from 1 to 6. The alkyl group may include, for example, a methyl group, an ethyl group, an n-propyl group, an isopropyl group, an n-butyl group, an s-butyl group, a t-butyl group, an i-butyl group, a 2-ethylbutyl group, a 3,3-dimethylbutyl group, an n-pentyl group, an i-pentyl group, a neopentyl group, a t-pentyl group, a cyclopentyl group, a 1-methylpentyl group, a 3-methylpentyl group, a 2-ethylpentyl group, a 4-methyl-2-pentyl group, an n-hexyl group, a 1-methylhexyl group, a 2-ethylhexyl group, a 2-butylhexyl group, a cyclohexyl group, a 4-methylcyclohexyl group, a 4-t-butylcyclohexyl group, an n-heptyl group, a 1-methylheptyl group, a 2,2-dimethylheptyl group, a 2-ethylheptyl group, a 2-butylheptyl group, an n-octyl group, t-octyl group, a 2-ethyloctyl group, a 2-butyloctyl group, a 2-hexyloctyl group, a 3,7-dimethyloctyl group, a cyclooctyl group, an n-nonyl group, an n-decyl group, an adamantyl group, a 2-ethyldecyl group, a 2-butyldecyl group, a 2-hexyldecyl group, a 2-octyldecyl group, an n-undecyl group, an n-dodecyl group, a 2-ethyldodecyl group, a 2-butyldodecyl group, a 2-hexyldocecyl group, a 2-octyldodecyl group, an n-tridecyl group, an n-tetradecyl group, an n-pentadecyl group, an n-hexadecyl group, a 2-ethylhexadecyl group, a 2-butylhexadecyl group, a 2-hexylhexadecyl group, a 2-octylhexadecyl group, an n-heptadecyl group, an n-octadecyl group, an n-nonadecyl group, an n-eicosyl group, a 2-ethyleicosyl group, a 2-butyleicosyl group, a 2-hexyleicosyl group, a 2-octyleicosyl group, an n-henicosyl group, an n-docosyl group, an n-tricosyl group, an n-tetracosyl group, an n-pentacosyl group, an n-hexacosyl group, an n-heptacosyl group, an n-octacosyl group, an n-nonacosyl group, or an n-triacontyl group, but the present disclosure is not limited thereto.

In this disclosure, the alkenyl group may refer to a hydrocarbon group containing one or more carbon double bonds in the middle or at the end of an alkyl group with two or more carbon atoms. The alkenyl group may be linear or branched. The number of carbon atoms is not particularly limited, but may range from 2 to 30, from 2 to 20, or from 2 to 10. The alkenyl group may be or include, for example, a vinyl group, a 1-butenyl group, a 1-pentenyl group, a 1,3-butadienyl group, a styrenyl group, or a styrylvinyl group, but the present disclosure is not limited thereto.

In this disclosure, the alkynyl group may refer to a hydrocarbon group containing one or more carbon triple bonds in the middle or at the end of an alkyl group with two or more carbon atoms. The alkynyl group may be linear or branched. The number of carbon atoms is not particularly limited, but may range from 2 to 30, from 2 to 20, or from 2 to 10. The alkynyl group may be or include, for example, an ethynyl group or a propynyl group, but the present disclosure is not limited thereto.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

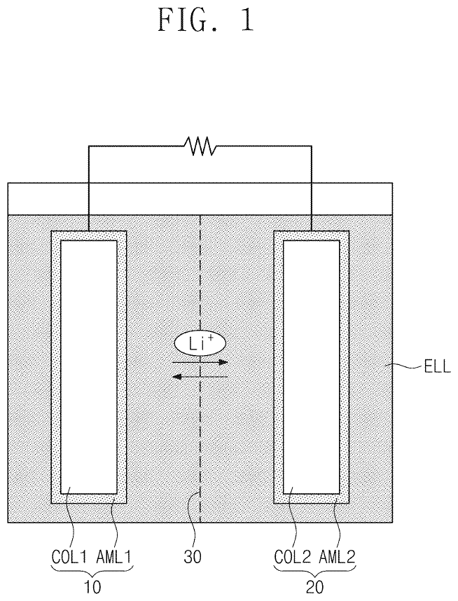

FIG. 1 illustrates a simplified conceptual diagram showing a rechargeable lithium battery according to an example embodiment of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced apart from each other across the separator 30. The separator 30 may be disposed between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated in the electrolyte ELL.

The electrolyte ELL may be or include a medium by which lithium ions are transferred between the positive electrode 10 and the negative electrode 20. In the electrolyte ELL, the lithium ions may move through the separator 30 toward one of the positive electrode 10 and the negative electrode 20.

### Positive Electrode 10

The positive electrode 10 for a rechargeable lithium battery may include a current collector COL1 and a positive electrode active material layer AML1 formed on the current collector COL1. The positive electrode active material layer AML1 may include a positive electrode active material and further include a binder and/or a conductive material.

For example, the positive electrode 10 may further include an additive that can constitute a sacrificial positive electrode.

An amount of the positive electrode active material may be about 90 wt % to about 99.5 wt % relative to 100 wt % of the positive electrode active material layer AML1. An amount of each, or at least one, of the binder and the conductive material may be about 0.5 wt % to about 5 wt % relative to 100 wt % of the positive electrode active material layer AML1.

The binder may improve attachment of positive electrode active material particles to each other, and also to improve attachment of the positive electrode active material to the current collector COL1. The binder may include, for example, at least one of polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, or nylon, but the present disclosure is not limited thereto.

The conductive material may constitute an electrode with conductivity, and any suitable conductive material that does not cause a chemical change in a battery may be included as the conductive material. The conductive material may include, for example, a carbon-based material such as at least one of natural graphite, artificial graphite, carbon black, acetylene black, Ketjen black, carbon fiber, carbon nano-fiber, and carbon nano-tube; a metal powder or metal fiber containing one or more of copper, nickel, aluminum, and silver; a conductive polymer such as a polyphenylene derivative; or a mixture thereof.

Aluminum (Al) may be included in the current collector COL1, but the present disclosure is not limited thereto.

### Positive Electrode Active Material

The positive electrode active material in the positive electrode active material layer AML1 may include a compound (e.g., lithiated intercalation compound) that can reversibly intercalate and deintercalate lithium. For example, the positive electrode active material may include at least one kind of composite oxide including lithium and metal that is or includes at least one of cobalt, manganese, nickel, and a combination thereof.

The composite oxide may include lithium transition metal composite oxide, for example, at least one of lithium-nickel-based oxide, lithium-cobalt-based oxide, lithium-manganese-based oxide, lithium-iron-phosphate-based compounds, cobalt-free nickel-manganese-based oxide, or a combination thereof.

For example, the positive electrode active material may include a compound expressed by one of chemical formulae below. LiₐA_{1-b}X_{b}O_{2-c}D_{c} (where 0.90≤a≤1.8, 0≤b≤0.5, and 0≤c≤0.05); LiₐMn_{2-b}X_{b}O_{4-c}D_{c} (where 0.90≤a≤1.8, 0≤b≤0.5, and 0≤c≤0.05); LiₐNi_{1-b-c}Co_{b}X_{c}O_{2-α}D_{α} (where 0.90≤a≤1.8, 0≤b≤0.5, 0≤c≤0.5, and 0<α<2); LiₐNi_{1-b-c}Mn_{b}X_{c}O_{2-α}D_{α} (where 0.90≤a≤1.8, 0≤b≥0.5, 0≤c≤0.5, and 0<α<2); LiₐNi_{b}Co_{c}L¹_{d}GₑO₂ (where 0.90≤a≤1.8, 0≤b≤0.9, 0≤c≤0.5, 0≤d≤0.5, and 0≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMn_{1-b}G_{b}O₂ (where 0.90≤a≤1.8 and 0.001≤b≤0.1); LiₐMn₂G_{b}O₄ (where 0.90≤a≤1.8 and 0.001≤b≤0.1); LiₐMn_{1-g}G_{g}PO₄ (where 0.90≤a≤1.8 and 0≤g≤0.5); Li_{(3-f)}Fe₂(PO₄)₃ (where 0≤f≤2); LiₐFePO₄ (where 0.90≤a≤1.8).

In the chemical formulae above, A is or includes at least one of Ni, Co, Mn, or a combination thereof, X is or includes at least one of Al, Ni, Co, Mn, Cr, Fe, Mg, Sr, V, a rare-earth element, or a combination thereof, D is or includes at least one of O, F, S, P, or a combination thereof, G is or includes at least one of Al, Cr, Mn, Fe, Mg, La, Ce, Sr, V, or a combination thereof, and L¹ is or includes at least one of Mn, Al, or a combination thereof.

For example, the positive electrode active material may be or include a high-nickel-based positive electrode active material having a nickel amount of equal to or greater than about 80 mol %, equal to or greater than about 85 mol %, equal to or greater than about 90 mol %, equal to or greater than about 91 mol %, or equal to or greater than about 94 mol % and equal to or less than about 99 mol % relative to 100 mol % of metal devoid of lithium in the lithium transition metal composite oxide. The high-nickel-based positive electrode active material may achieve high capacity and thus may be applied to a high-capacity and high-density rechargeable lithium battery.

### Negative Electrode 20

The negative electrode 20 for a rechargeable lithium battery may include a current collector COL2 and a negative electrode active material layer AML2 positioned on the current collector COL2. The negative electrode active material layer AML2 may include a negative electrode active material, and may further include a binder and/or a conductive material.

For example, the negative electrode active material layer AML2 may include a negative electrode active material of about 90 wt % to about 99 wt %, a binder of about 0.5 wt % to about 5 wt %, and a conductive material of about 0 wt % to about 5 wt %.

The binder may improve attachment of negative electrode active material particles to each other, and also to improve attachment of the negative electrode active material to the current collector COL2. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, or a combination thereof.

The aqueous binder may include styrene-butadiene rubber, (meth)acrylated styrene-butadiene rubber, (meth)acrylonitrile-butadiene rubber, (meth)acrylic rubber, butyl rubber, fluororubber, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, or a combination thereof.

When an aqueous binder is the negative electrode binder, a thickener or a cellulose-based compound capable of providing viscosity may further be included. A cellulose-based compound may be included as the thickener. The cellulose-based compound may include one or more of carboxymethyl cellulose, hydroxypropylmethyl cellulose, methyl cellulose, and alkali metal salts thereof. The alkali metal may include at least one of Na, K, or Li.

The dry binder may include a fibrillizable polymer material, for example, at least one of polytetrafluoroethylene, polyvinylidene fluoride, polyvinylidene fluoride-hexafluoropropylene copolymer, polyethylene oxide, or a combination thereof.

The conductive material may constitute an electrode with conductivity, and any suitable conductive material that does not cause a chemical change in a battery may be included as the conductive material. For example, the conductive material may include a carbon-based material such as at least one of natural graphite, artificial graphite, carbon black, acetylene black, Ketjen black, carbon fiber, carbon nano-fiber, and carbon nano-tube; a metal powder or metal fiber including one or more of copper, nickel, aluminum, and silver; a conductive polymer such as a polyphenylene derivative; or a mixture thereof.

The current collector COL2 may include at least one of a copper foil, a nickel foil, a stainless-steel foil, a titanium foil, a nickel foam, a copper foam, a polymer substrate coated with a conductive metal, or a combination thereof.

### Negative Electrode Active Material

The negative electrode active material in the negative electrode active material layer AML2 may include at least one of a material that can reversibly intercalate and deintercalate lithium ions, lithium metal, a lithium metal alloy, a material that can dope and de-dope lithium, or transition metal oxide.

The material that can reversibly intercalate and deintercalate lithium ions may include a carbon-based negative electrode active material, for example, crystalline carbon, amorphous carbon, or a combination thereof. For example, the crystalline carbon may include graphite such as at least one of non-shaped, sheet-shaped, flake-shaped, sphere-shaped, or fiber-shaped natural or artificial graphite, and the amorphous carbon may include at least one of soft carbon, hard carbon, mesophase pitch carbon, or calcined coke.

The lithium metal alloy may include an alloy of lithium and metal that is or includes at least one of Na, K, Rb, Cs, Fr, Be, Mg, Ca, Sr, Si, Sb, Pb, In, Zn, Ba, Ra, Ge, Al, and Sn.

The material that can dope and de-dope lithium may include a Si-based negative electrode active material or a Sn-based negative electrode active material. The Si-based negative electrode active material may include at least one of silicon, silicon-carbon composite, SiOₓ (where 0<x<2), Si-Q alloy (where Q is or includes at least one of alkali metal, alkaline earth metal, Group 13 element, Group 14 element (except for Si), Group 15 element, Group 16 element, transition metal, a rare-earth element, or a combination thereof), or a combination thereof. The Sn-based negative electrode active material may include at least one of Sn, SnO₂, a Sn-based alloy, a combination thereof.

The silicon-carbon composite may be or include a composite of silicon and amorphous carbon. According to an example embodiment, the silicon-carbon composite may have a structure in which the amorphous carbon is coated on a surface of the silicon particle. For example, the silicon-carbon composite may include a secondary particle (core) in which primary silicon particles are assembled, and an amorphous carbon coating layer (shell) positioned on a surface of the secondary particle. The amorphous carbon may also be positioned between the primary silicon particles, and for example, the primary silicon particles may be coated with the amorphous carbon. The secondary particles may be dispersed in an amorphous carbon matrix.

The silicon-carbon composite may further include crystalline carbon. For example, the silicon-carbon composite may include a core including crystalline carbon and silicon particles, and may also include an amorphous carbon coating layer positioned on a surface of the core.

The Si-based negative electrode active material or the Sn-based negative electrode active material may be used in combination with a carbon-based negative electrode active material.

### Separator 30

Based on type of the rechargeable lithium battery, the separator 30 may be present between positive electrode 10 and the negative electrode 20. The separator 30 may include one or more of polyethylene, polypropylene, and polyvinylidene fluoride, and may have a multi-layered separator thereof such as at least one of a polyethylene/polypropylene bi-layered separator, a polyethylene/polypropylene/polyethylene tri-layered separator, and a polypropylene/polyethylene/polypropylene tri-layered separator.

The separator 30 may include a porous substrate and a coating layer positioned on one or opposite surfaces of the porous substrate, which coating layer includes an organic material, an inorganic material, or a combination thereof.

The porous substrate may be or include a polymer layer including a polyolefin such as or including at least one of polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulphide, polyethylene naphthalate, glass fiber, Teflon, and polytetrafluoroethylene, or may be or include a copolymer or mixture including two or more of the materials mentioned above.

The organic material may include a polyvinylidenefluoride-based copolymer or a (meth)acrylic copolymer.

The inorganic material may include an inorganic particle including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, or a combination thereof, but the present disclosure is not limited thereto.

The organic material and the inorganic material may be mixed in one coating layer, or may be present as a stack of a coating layer including the organic material and a coating layer including an inorganic material.

### Electrolyte ELL

The electrolyte ELL for the rechargeable lithium battery may include a non-aqueous organic solvent and a lithium salt.

The non-aqueous organic solvent may be a medium for transmitting ions that participate in an electrochemical reaction of the battery.

The non-aqueous organic solvent may include at least one of a carbonate-based solvent, an ester-based solvent, an ether-based solvent, a ketone-based solvent, an alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), or butylene carbonate (BC).

The ester-based solvent may include at least one of methyl acetate, ethyl acetate, n-propyl acetate, dimethyl acetate, methyl propionate, ethyl propionate, decanolide, mevalonolactone, valerolactone, or caprolactone.

The ether-based solvent may include at least one of dibutyl ether, tetraglyme, diglyme, dimethoxyethane, 2-methyltetrahydrofuran, 2.5-dimethyltetrahydrofuran, or tetrahydrofuran. The ketone-based solvent may include cyclohexanone. The alcohol-based solvent may include ethyl alcohol or isopropyl alcohol. The aprotic solvent may include at least one of nitriles such as R—CN (where R is a hydrocarbon group having a C2 to C20 linear, branched, or cyclic structure and may include a double bond, an aromatic ring, or an ether group), amides such as dimethylformamide; dioxolanes such as 1,3-dioxolane or 1.4-dioxolane, or sulfolanes.

The non-aqueous organic solvent may be used alone or in a mixture of two or more substances.

In addition, when a carbonate-based solvent is used, a cyclic carbonate and a chain carbonate may be mixed and used, and the cyclic carbonate and the chain carbonate may be mixed in a volume ratio of about 1:1 to about 1:9.

The lithium salt may be or include a material that dissolves in the non-aqueous organic solvent to constitute a supply source of lithium ions in a battery and plays a role in enabling a basic operation of a rechargeable lithium battery and in promoting the movement of lithium ions between positive and negative electrodes. The lithium salt may include, for example, at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (where x and y are integers between 1 and 20), lithium trifluoromethane sulfonate, lithium tetrafluoroethanesulfonate, lithium difluorobis(oxalato)phosphate (LiDFBOP), and lithium bis(oxalato) borate (LiBOB)

### Rechargeable Lithium Battery

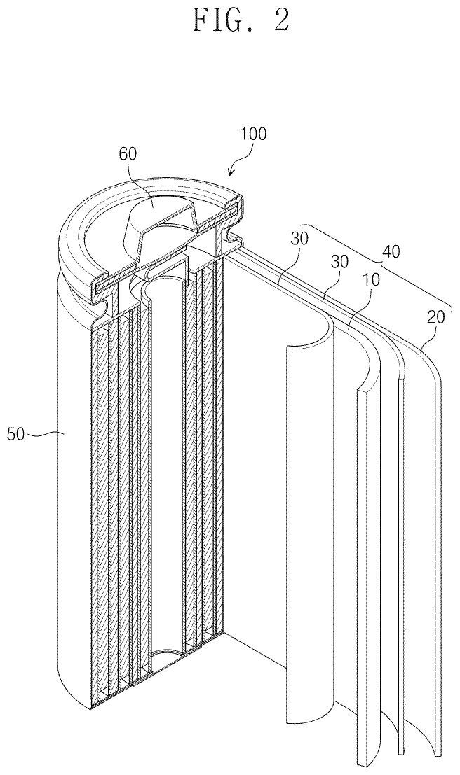

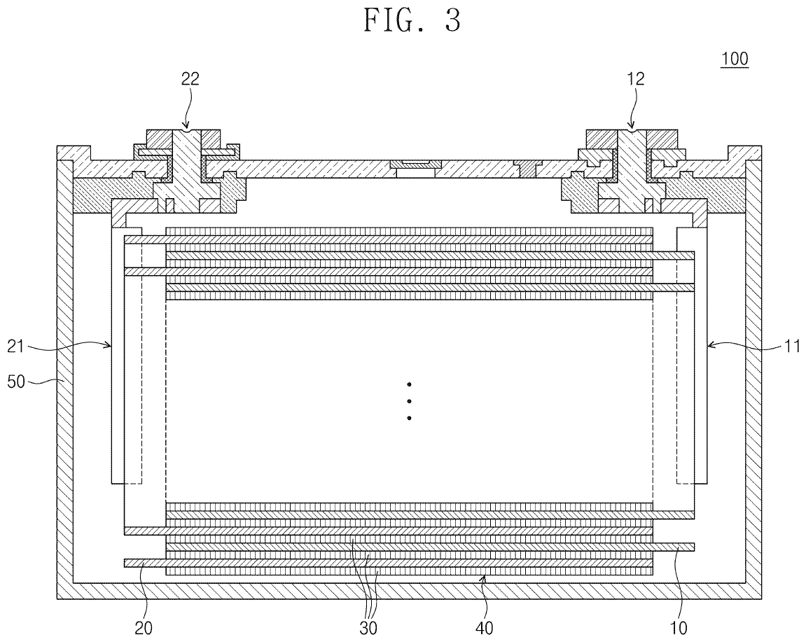

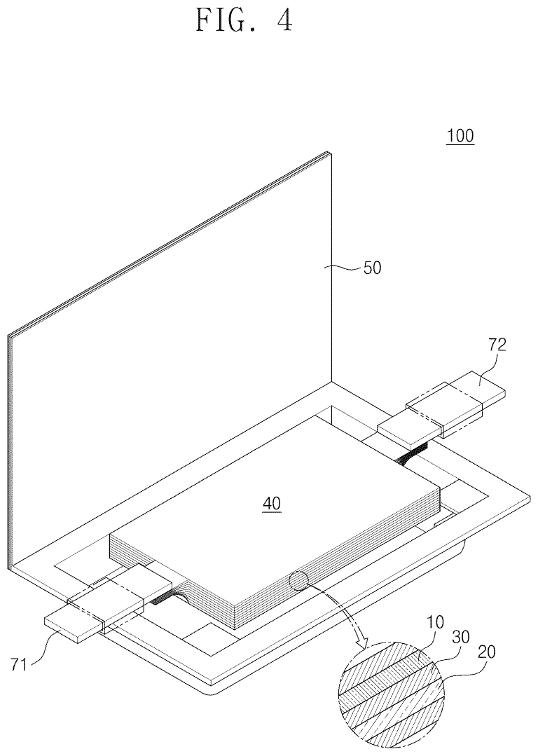

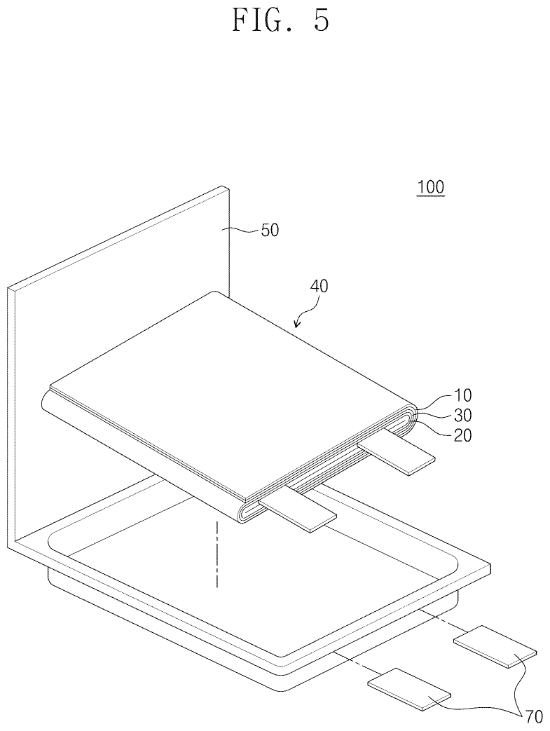

Based on the shape of the rechargeable lithium battery, the rechargeable lithium battery may be classified into cylindrical, prismatic, pouch, and coin types. FIGS. 2 to 5 illustrate simplified diagrams showing a rechargeable lithium battery according to an example embodiment, with FIG. 2 showing a cylindrical battery, FIG. 3 showing a prismatic battery, and FIGS. 4 and 5 showing pouch-type batteries. Referring to FIGS. 2 to 5, a rechargeable lithium battery 100 may include an electrode assembly 40 in which a separator 30 is interposed between a positive electrode 10 and a negative electrode 20, and may also include a casing 50 in which the electrode assembly 40 is accommodated. The positive electrode 10, the negative electrode 20, and the separator 30 may be impregnated in an electrolyte (not shown). The rechargeable lithium battery 100 may include a sealing member 60 that seals the casing 50 as illustrated in FIG. 2. In addition, as illustrated in FIG. 3, the rechargeable lithium battery 100 may include a positive electrode lead tab 11, a positive electrode terminal 12, a negative electrode lead tab 21, and a negative electrode terminal 22. As shown in FIGS. 4 and 5, the rechargeable lithium battery 100 may include an electrode tab 70 as illustrated in FIG. 5, or a positive electrode tab 71 and a negative electrode tab 72 as illustrated in FIG. 4, which electrode tab 70 forms an electrical path for externally inducing a current generated in the electrode assembly 40 outside of the battery 100.

The following description will focus on a rechargeable lithium battery according to some example embodiments of the present disclosure.

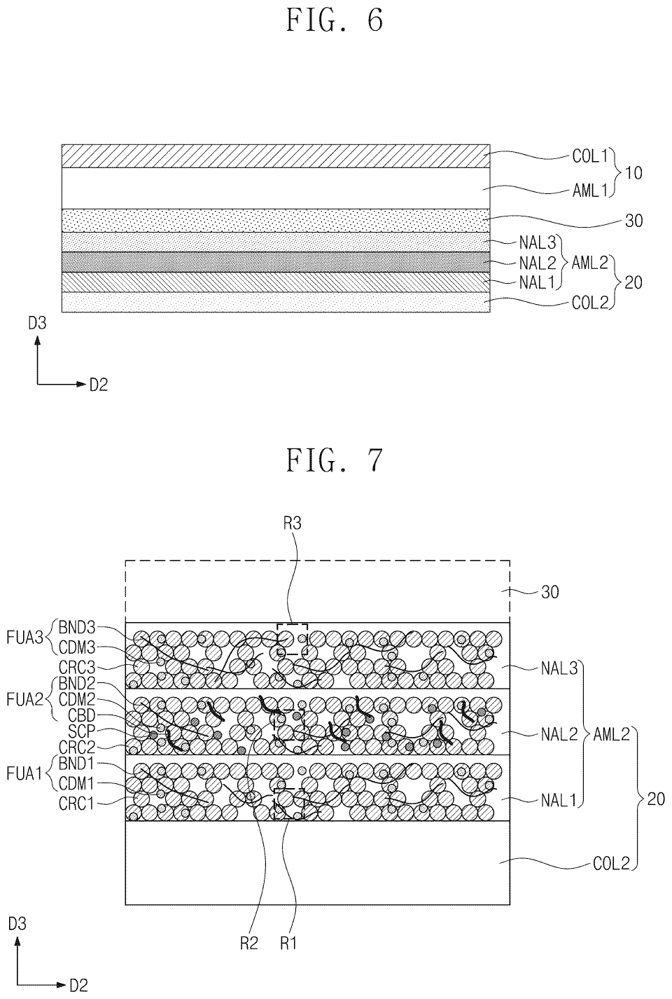

FIG. 6 illustrates a cross-sectional view showing a rechargeable lithium battery according to an example embodiment of the present disclosure. FIG. 7 illustrates an enlarged view showing a negative electrode for a rechargeable lithium battery according to an example embodiment of the present disclosure.

Referring to FIG. 6, as discussed above with reference to FIG. 1, a rechargeable lithium battery according to the present disclosure may include a positive electrode 10, a negative electrode 20, and a separator 30 between the positive electrode 10 and the negative electrode 20. Although not explicitly shown in FIG. 6, the rechargeable lithium battery according to the present disclosure may further include an electrolyte ELL. The separator 30 may be impregnated in the electrolyte ELL.

The positive electrode 10 may include a positive electrode current collector COL1 and a positive electrode active material layer AML1 on the positive electrode current collector COL1. The negative electrode 20 may include a negative electrode current collector COL2 and a negative electrode active material layer AML2 on the negative electrode current collector COL2. The separator 30 may be interposed between the positive electrode active material layer AML1 and the negative electrode active material layer AML2.

Referring to FIG. 6 and FIG. 7, the negative electrode active material layer AML2 according to an example embodiment of the present disclosure may have a multilayered structure. For example, the negative electrode active material layer AML2 may include a first active material layer NAL1, a second active material layer NAL2, and a third active material layer NAL3 that are stacked, e.g., sequentially stacked. The first active material layer NAL1 may be directly provided on the negative electrode current collector COL2. The second active material layer NAL2 may be interposed between the first active material layer NAL1 and the third active material layer NAL3.

The first to third active material layers NAL1 to NAL3 may include negative electrode active materials that are different from each other. The first to third active material layers NAL1 to NAL3 may have compositions that are different from each other. Each, or at least one, of the first to third active material layers NAL1 to NAL3 may include a carbon-based negative electrode active material, such as crystalline carbon, amorphous carbon, or any combination thereof. A detailed description thereof may be the same as the description of the negative electrode active material.

Referring to FIG. 7, first active material layer NAL1 may include a first crystalline carbon CRC1. The second active material layer NAL2 may include a second crystalline carbon CRC2 and a silicon-containing particle SCP. The third active material layer NAL3 may include a third crystalline carbon CRC3. Each, or at least one, of the first to third crystalline carbons CRC1 to CRC3 may be or include natural graphite, artificial graphite, or any mixture thereof.

In an example embodiment, each, or at least one, of the first active material layer NAL1 and the third active material layer NAL3 may further include a silicon-containing particle SCP, and an amount of the silicon-containing particle SCP included in each, or at least one, of the first and third active material layers NAL1 and NAL3 may be less than the amount of the silicon-containing particle SCP included in the second active material layer NAL2.

In an example embodiment of the present disclosure, a ratio of natural graphite among the first crystalline carbon CRC1 of the first active material layer NAL1 may be in a range of about 0 wt % to about 100 wt %, about 50 wt % to about 100 wt %, or about 80 wt % to about 100 wt %. In the first crystalline carbon CRC1 of the first active material layer NAL1, the ratio of natural graphite may be greater than the ratio of artificial graphite. In an example embodiment of the present disclosure, a ratio of artificial graphite among the third crystalline carbon CRC3 of the third active material layer NAL3 may be in a range of about 0 wt % to about 100 wt %, about 50 wt % to about 100 wt %, or about 80 wt % to about 100 wt %. In the third crystalline carbon CRC3 of the third active material layer NAL3, the ratio of artificial graphite may be greater than the ratio of natural graphite. For example, the first active material layer NAL1 may include natural graphite, the third active material layer NAL3 may include artificial graphite, and the second active material layer NAL2 may include a mixture of natural graphite and artificial graphite.

In an example embodiment of the present disclosure, the second active material layer NAL2 may further include an amorphous carbon and a silicon particle. The second active material layer NAL2 may include a silicon-carbon composite as the silicon-containing particle SCP which will be discussed below.

The second active material layer NAL2 may include carbon (C) and silicon (Si). The silicon (Si) may be originated from the silicon-containing particle SCP. The carbon (C) may be originated from at least one of crystalline carbon, amorphous carbon, and carbon in the silicon-containing particle SCP.

A ratio of Si in the second active material layer NAL2 may be in a range of about 5 wt % to about 99 wt %, about 5 wt % to about 30 wt %, or about 5 wt % to about 10 wt %. The silicon-containing particle SCP may include at least one of silicon, silicon-carbon composite, SiOₓ (where 0<x<2), Si-Q alloy (where Q is or includes at least one of alkali metal, alkaline earth metal, Group 13 element, Group 14 element (except for Si), Group 15 element, Group 16 element, transition metal, a rare-earth element, or any combination thereof), or any combination thereof.

As the second active material layer NAL2 includes the silicon-containing particle SCP, the second active material layer NAL2 may have an increased volume during charge of the rechargeable lithium battery. For example, a thickness of the second active material layer NAL2 may increase when the rechargeable lithium battery is charged. In contrast, the first active material layer NAL1 and the third active material layer NAL3 that are formed of or include only crystalline carbon may have no large variation in volume (or thickness). This may be caused by the fact that, when the rechargeable lithium battery is charged, the silicon-containing particle SCP intercalates lithium ions more than crystalline carbon. During charge and discharge of the rechargeable lithium battery, the first active material layer NAL1 and the third active material layer NAL3 may constitute a buffer layer to reduce a variation in volume (or thickness) of the second active material layer NAL2.

Each, or at least one, of the first to third active material layers NAL1 to NAL3 may further include a functional additive. For example, the first active material layer NAL1 may include a first functional additive FUA1. The second active material layer NAL2 may include a second functional additive FUA2. The third active material layer NAL3 may include a third functional additive FUA3. The first functional additive FUA1 may include a first binder BND1. The second functional additive FUA2 may include a conductive binder CBD and a second binder BND2. The third functional additive FUA3 may include a third binder BND3.

During charge and discharge procedure, the silicon-containing particle SCP in the second active material layer NAL2 may repeatedly expand and shrink, which may cause damage to an ion delivery pathway in the second active material layer NAL2. Thus, an ion resistance may increase, and the rechargeable lithium battery may have a reduced charge-discharge rate. As the second active material layer NAL2 includes the conductive binder CBD, the second active material layer NAL2 may improve the ion conductivity thereof. As a result, the rechargeable lithium battery may improve in charge and discharge rate. A kind of the conductive binder CBD will be discussed below.

In an example embodiment, although not shown, the first functional additive FUA1 and the third functional additive FUA3 may also include a conductive binder CBD. However, as the first active material layer NAL1 and the third active material layer NAL3 include either no silicon-containing particle SCP, or a slight amount of the silicon-containing particle SCP, an effect of reduction in ion resistance due to the addition of the conductive binder CBD may be relatively small. Therefore, an amount of the conductive binder CBD included in each, or at least one, of the first and third functional additives FUA1 and FUA3 may be less than the amount of the conductive binder CBD included in the second functional additive FUA2.

Each, or at least one, of the first to third binders BND1 to BND3 may include a non-aqueous binder, an aqueous binder, a dry binder, or a combination thereof. Each, or at least one, of the non-aqueous binder, the aqueous binder, and the dry binder may be or include at least one of the binders discussed in explaining the negative electrode 20 with reference to FIG. 1.

In an example embodiment, each, or at least one, of the first to third binders BND1 to BND3 may be or include an aqueous binder including at least one of styrene-butadiene rubber, (meth)acrylated styrene-butadiene rubber, (meth)acrylonitrile-butadiene rubber, (meth)acrylic rubber, butyl rubber, fluororubber, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, and a combination thereof. For example, each, or at least one, of the first to third binders BND1 to BND3 may be or include a rubber-based binder that includes at least one of styrene-butadiene rubber, (meth)acrylated styrene-butadiene rubber, (meth)acrylonitrile-butadiene rubber, (meth)acrylic rubber, butyl rubber, and fluororubber.

Each, or at least one, of the first to third binders BND1 to BND3 may further include a thickener capable of providing viscosity to slurry. For example, each, or at least one, of the first to third binders BND1 to BND3 may further include a cellulose-based compound discussed with reference to FIG. 1.

As the conductive binder CBD is capable of providing viscosity to slurry, the conductive binder CBD may replace the thickener. Thus, the second binder BND2 may include a no cellulose-based compound. Alternatively, the second binder BND2 may include a cellulose-based compound, which amount is less than the amount of the cellulose-based compound included in each, or at least one, of the first and third binders BND1 and BND3.

The first functional additive FUA1 may further include a first conductive material CDM1. The second functional additive FUA2 may further include a second conductive material CDM2. The third functional additive FUA3 may further include a third conductive material CDM3.

Each, or at least one, of the first to third conductive materials CDM1 to CDM3 may be or include at least one of the conductive materials of the negative electrode 20 discussed with reference to FIG. 1. For example, each, or at least one, of the first to third conductive materials CDM1 to CDM3 may include a carbon-based material such as at least one of natural graphite, artificial graphite, carbon black, acetylene black, Ketjen black, carbon fiber, carbon nano-fiber, and carbon nano-tube; a metal powder or metal fiber containing one or more of copper, nickel, aluminum, and silver; a conductive polymer such as a polyphenylene derivative; or a mixture thereof.

In an example embodiment, in the negative electrode active material layer AML2, an amount of the first binder BND1 may be about the same as the amount of the third binder BND3.

In an example embodiment, in the negative electrode active material layer AML2, an amount of the first binder BND1 may be greater than the amount of the third binder BND3. In an example embodiment, in the negative electrode active material layer AML2, an amount of the first binder BND1 may be less than the amount of the third binder BND3. A relatively large amount of binder may be distributed in the first active material layer NAL1 in contact with the negative electrode current collector COL2, and it may thus be possible to maintain an energy density, and to contemporaneously increase an adhesive force between a current collector and an active material layer.

In an example embodiment, the first functional additive FUA1 in the first active material layer NAL1 may have an amount of about 2 wt % to about 10 wt %. For example, the first binder BND1 in the first active material layer NAL1 may have an amount of about 2 wt % to about 5 wt %. The first binder BND1 may include an aqueous binder and a thickener. The first conductive material CDM1 in the first active material layer NAL1 may have an amount of about 0 wt % to about 5 wt %.

In an example embodiment, the second functional additive FUA2 in the second active material layer NAL2 may have an amount of about 2 wt % to about 12 wt %. For example, the conductive binder CBD in the second active material layer NAL2 may have an amount of about 0.5 wt % to about 4 wt %. The second binder BND2 in the second active material layer NAL2 may have an amount of about 1.5 wt % to about 5 wt %. The second binder BND2 may include an aqueous binder. The second conductive material CDM2 in the second active material layer NAL2 may have an amount of about 0 wt % to about 5 wt %.

As the conductive binder CBD in the second active material layer NAL2 has an amount of about 0.5 wt % to about 4 wt %, a cell may increase in both capacity and rapid charge rate.

In an example embodiment, the third functional additive FUA3 in the third active material layer NAL3 may be present in an amount of about 1 wt % to about 10 wt %. For example, the third binder BND3 in the third active material layer NAL3 may be present in an amount of about 1 wt % to about 5 wt %. The third binder BND3 may include an aqueous binder and a thickener. The third conductive material CDM3 in the third active material layer NAL3 may be present in an amount of about 0 wt % to about 5 wt %.

In an example embodiment, each, or at least one, of the first to third active material layers NAL1 to NAL3 may have a thickness of about 10 μm to about 50 μm.

In an example embodiment, the first to third active material layers NAL1 to NAL3 may have substantially the same thickness.

Alternatively, the second active material layer NAL2 may have a thickness greater than the thickness of the first active material layer NAL1. The thickness of the second active material layer NAL2 may be greater than the thickness of the third active material layer NAL3.

In an example embodiment, no distinct interfaces may be present between the first active material layer NAL1, the second active material layer NAL2, and the third active material layer NAL3. When the interfaces are not clearly distinguished, the interfaces may be determined through a concentration profile of silicon particles, or a concentration profile of the conductive binder CBD. For example, since amounts of the silicon particles and the conductive binder CBD are abruptly increased in the second active material layer NAL2, the second active material layer NAL2 may refer to a section where concentrations of the silicon particles and the conductive binder CBD are sharply increased and then rapidly decreased again, the third active material layer NAL3 may be referred to as a layer above the second active material layer NAL2, and the first active material layer NAL1 may be referred to as a layer below the second active material layer NAL2.

For example, the determination of the interface through the concentration profile may be carried out in the following manner. A concentration of the silicon particles or the conductive binder CBD may be measured depending on a depth of the negative electrode active material layer AML2. There may be no particular limitation on the concentration measurement method, and for example, an optical method, an electron microscope analysis method, or an X-ray diffraction analysis method may be utilized. The concentration measurement method may measure a point where a concentration of the silicon particles or the conductive binder CBD is abruptly increased, and then may measure a point where a concentration of the silicon particles or the conductive binder CBD is rapidly decreased. Since amounts of the silicon particles and the conductive binder CBD are abruptly increased in the second active material layer NAL2, the second active material layer NAL2 may refer to a region from the point where a concentration of the silicon particles or the conductive binder CBD is abruptly increased to the point where a concentration of the silicon particles or the conductive binder CBD is rapidly decreased. Afterwards, the first active material layer NAL1 may refer to a region (or a layer directed toward the negative electrode current collector COL2) of the negative electrode active material layer AML2 on a bottom surface of the second active material layer NAL2, and the third active material layer NAL3 may refer to a region (or a layer directed toward the separator 30) of the negative electrode active material layer AML2 on a top surface of the second active material layer NAL2.

For example, the “abrupt increase” in concentration may be a concentration increase of 50%, 100%, or 200% over a distance of 10 nm, and “rapid decrease” concentration may be a concentration decrease of 50%, 100%, or 200% over a distance of 10 nm.

Referring back to FIG. 7, a first region R1 may refer to a given sized space in the first active material layer NAL1. A second region R2 may refer to a given sized space in the second active material layer NAL2. A third region R3 may refer to a given sized space in the third active material layer NAL3. For example, the first region R1 may be a cubic space of about 100 nm×100 nm×100 nm in the first active material layer NAL1, the second region R2 may be a cubic space of about 100 nm×100 nm×100 nm in the second active material layer NAL2, and the third region R3 may be a cubic space of about 100 nm×100 nm×100 nm in the third active material layer NAL3. A concentration of the silicon particles or the conductive binder CBD in the first to third regions R1 to R3 may be measured to determine a concentration of the silicon particles or the conductive binder CBD in the first to third active material layers NAL1 to NAL3, respectively.

In an example embodiment, a composition of a partial region in the first to third active material layers NAL1 to NAL3 may be analyzed without determination of the interfaces to determine a concentration of the silicon particle or the conductive binder CBD in the first to third active material layers NAL1 to NAL3, respectively. The first to third regions R1 to R3 may be defined in the following manner.

Referring again to FIG. 7, the first region R1 may refer to a cubic space (about 100 nm×100 nm×100 nm) centered around a point at a given distance in a third direction D3 from one surface of the negative electrode active material layer AML2 adjacent to the negative electrode current collector COL2. For example, the given distance may range from about 100 nm to about 200 nm.

The second region R2 may refer to a cubic space (about 100 nm×100 nm×100 nm) centered around a point at a given distance in the third direction D3 or its opposite direction from the center (or the middle) of a thickness in the third direction D3 of the negative electrode active material layer AML2. For example, the given distance may be about 100 nm.

The third region R3 may refer to a cubic space (100 nm×100 nm×100 nm) centered around a point at a given distance in the third direction D3 or an opposite direction thereof from a top surface of the negative electrode active material layer AML2 or one surface of the negative electrode active material layer AML2 adjacent to the separator 30. For example, the given distance may range from about 100 nm to about 200 nm.

In an example embodiment, the second region R2 may be interposed, e.g., substantially vertically interposed, between the first region R1 and the third region R3.

A concentration of the silicon particles or the conductive binder CBD in the first to third regions R1 to R3 defined as discussed above may be measured to determine a concentration of the silicon particles or the conductive binder CBD in the first to third active material layers NAL1 to NAL3, respectively.

The following description will focus on a conductive binder.

### Conductive Binder CBD

The conductive binder CBD included in the second functional additive FUA2 may include a unit derived from a first monomer, a unit derived from a second monomer, and a unit derived from a third monomer. The first monomer may be or include a (meth)acrylic monomer having a carboxylic acid group. The second monomer may be or include a (meth)acrylic monomer having an amide group or a nitrile group. The third monomer may be or include a zwitterion having both of a cationic functional group and an anionic functional group. For example, the third monomer may be or include a zwitterionic vinyl monomer or a zwitterionic (meth)acrylic monomer.

The first monomer-derived unit and the second monomer-derived unit may provide the conductive binder CBD with a desired or improved adhesive force. Thus, the conductive binder CBD that does not include the unit derived from the first monomer or the second monomer may have low solubility in water and low viscosity, thereby having difficulty in providing an appropriate adhesive force.

The third monomer-derived unit may provide the conductive binder CBD with a desired or improved ion conductivity.

In an example embodiment, the conductive binder CBD may be formed of or include a unit derived from the first monomer, a unit derived from the second monomer, and a unit derived from the third monomer. For example, the conductive binder CBD may be or include a copolymer of the first monomer, the second monomer, and the third monomer.

The first monomer may be or include a (meth)acrylic monomer having a carboxylic acid group (—COOH) or a carboxylic acid metal salt. For example, the (meth)acrylic monomer may include one or more of acrylic acid and methacrylic acid. For example, the carboxylic metal salt may be or include a carboxylate lithium salt.

In an example embodiment, the first monomer-derived unit in the conductive binder CBD may have a ratio of about 25 wt % to about 55 wt %. For example, the ratio of the first monomer-derived unit in the conductive binder CBD may range from about 25 wt % to about 50 wt %, from about 30 wt % to about 50 wt %, from about 30 wt % to about 45 wt %, or from about 35 wt % to about 45 wt %.

The second monomer may include one or more of a (meth)acrylic monomer having an amide group and a (meth)acrylic monomer having a nitrile group. For example, the second monomer may be or include a (meth)acrylic monomer having a nitrile group.

The (meth)acrylic monomer having an amide group may be or include, for example, at least one of (meth)acrylamide, N-monoalkyl (meth)acrylamide, and N,N-dialkyl (meth)acrylamide.

The (meth)acrylic monomer having a nitrile group may be or include, for example, (meth)acrylonitrile.

In an example embodiment, the second monomer-derived unit in the conductive binder CBD may have a ratio of about 25 wt % to about 50 wt %. For example, the ratio of the second monomer-derived unit in the conductive binder CBD may range from about 30 wt % to about 50 wt %, from about 35 wt % to about 50 wt %, or from about 40 wt % to about 50 wt %.

As the first monomer and the second monomer have the ratio range mentioned above, the conductive binder CBD may have appropriate viscosity and adhesive force.

The third monomer may include a zwitterionic monomer having both of a cationic functional group and an anionic functional group. For example, the third monomer may include one or more of a zwitterionic vinyl monomer and a zwitterionic (meth)acrylic monomer. In an example embodiment, the third monomer may include one or more of compounds represented by Chemical Formula 1, Chemical Formula 2, Chemical Formula 3, Chemical Formula 4, and Chemical Formulae 5-1 to 5-19.

In an example embodiment, the third monomer-derived unit in the conductive binder CBD may have a ratio of about 2 wt % to about 45 wt %. For example, the ratio of the third monomer-derived unit in the conductive binder CBD may range from about 5 wt % to about 35 wt %, from about 10 wt % to about 35 wt %, or from about 10 wt % to about 30 wt %. When the third monomer has the ratio mentioned above, the conductive binder CBD may maintain adhesive force and may simultaneously or contemporaneously have increased ion conductivity.

The cationic functional group may be or include a functional group that exhibits a monovalent or polyvalent positive charge in an aqueous solvent, and for example may include at least one of a substituted or unsubstituted ammonium cation (NH4⁺), imidazolium cation, pyrazolium cation, pyridinium cation, piperidinium cation, piperazinium cation, sulfonium cation (—S⁺RₐR_{b}), naphthalenium cation, or guanidinium cation. The Rₐ and R_{b} may each independently be hydrogen or a C1 to C10 alkyl group. For example, the anionic functional group in the third monomer may be or include a substituted or unsubstituted ammonium cation or a substituted or unsubstituted imidazolium cation.

The anionic functional group may be or include a functional group which exhibits a monovalent or polyvalent negative charge in an aqueous solvent, and for example may include a functional group containing one or more of sulfur(S), nitrogen (N), carbon (C), phosphorus (P), and oxygen (O). For example, the anionic functional group may be sulfonate (—SO₃⁻), carboxylate (—CO₂⁻), oxygen anion (—O⁻), amine anion (—NR_{c}⁻), or dialkyl phosphate (—R_{d}—O—(P═O)O⁻O—Rₑ—). The Re may be or include a substituted or unsubstituted C1 to C10 alkyl group or a substituted or unsubstituted C1 to C10 haloalkyl group, and the R_{d} and Rₑ may each independently be or include a substituted or unsubstituted C1 to C10 alkylene group or a substituted or unsubstituted C2 to C10 alkenylene group.

For example, the zwitterionic (meth)acrylic monomer may be or include at least one of a sulfobetaine monomer, a phosphobetaine monomer, or a carboxybetaine monomer.

For example, the zwitterionic vinyl monomer may be or include a imidazolium monomer.

In an example embodiment, the sulfobetaine monomer may be or include a compound represented by Chemical Formula 1 below.

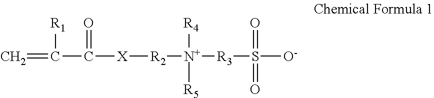

In Chemical Formula 1, R₁ may be hydrogen or a methyl group.
X may be or include oxygen (O) or NH.
R₂ and R₃ may each independently be or include at least one of a C1 to C10 alkylene group, a C6 to C10 arylene group, or a C7 to C10 arylalkylene group.
R₄ and R₅ may each independently be hydrogen or a C1 to C10 alkyl group. The alkylene group, the arylene group, the arylalkylene group, and the alkyl group may each be substituted or unsubstituted.

In an example embodiment, the substituted alkyl group may be or include a C1 to C10 alkyl group substituted with a (meth)acrylate group.

For example, the sulfobetaine monomer may include one or more of compounds represented by Chemical Formulae 1-1 to 1-8 below.

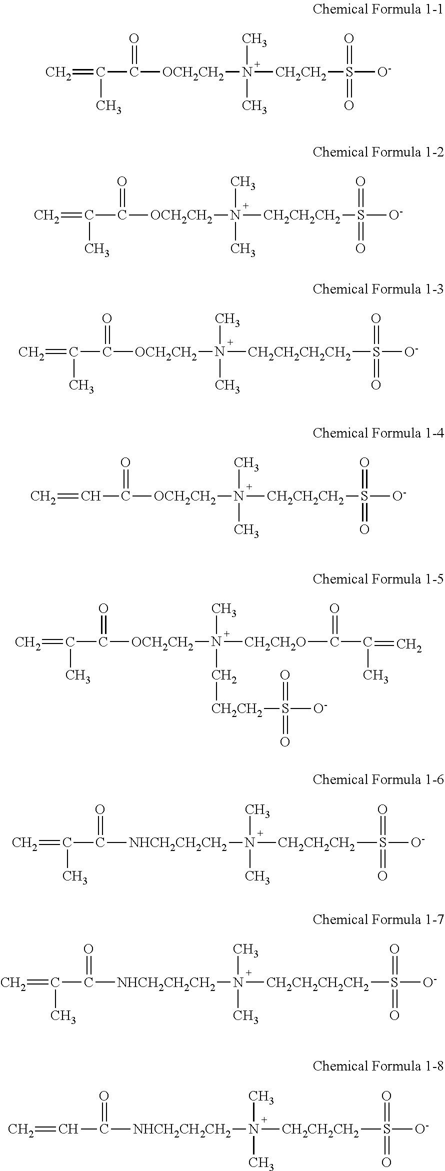

In an example embodiment, the phosphobetaine monomer may be or include a compound represented by Chemical Formula 2 below.

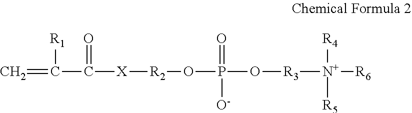

In Chemical Formula 2, R₁ may be hydrogen or a methyl group.
X may be or include oxygen (O) or NH.
R₂ and R₃ may each independently be or include a C1 to C10 alkylene group, a C6 to C10 arylene group, or a C7 to C10 arylalkylene group.
R₄, R₅, and R₆ may each independently be hydrogen or a C1 to C10 alkyl group. The alkylene group, the arylene group, the arylalkylene group, and the alkyl group may each be substituted or unsubstituted.

For example, the phosphobetaine monomer may be or include a compound represented by Chemical Formula 2-1 below.

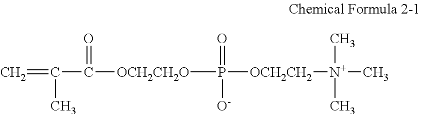

In an example embodiment, the carboxybetaine monomer may be or include a compound represented by Chemical Formula 3 below.

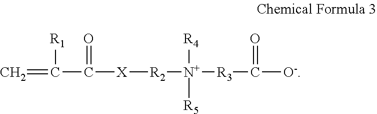

In Chemical Formula 3, R₁ may be hydrogen or a methyl group. X may be or include oxygen (O) or NH. R₂ and R₃ may each independently be or include a C1 to C10 alkylene group, a C6 to C10 arylene group, or a C7 to C10 arylalkylene group. R₄ and R₅ may each independently be hydrogen or a C1 to C10 alkyl group. The alkylene group, the arylene group, the arylalkylene group, and the alkyl group may each be substituted or unsubstituted.

For example, the carboxybetaine monomer may include one or more of compounds represented by Chemical Formulae 3-1 to 3-3 below.

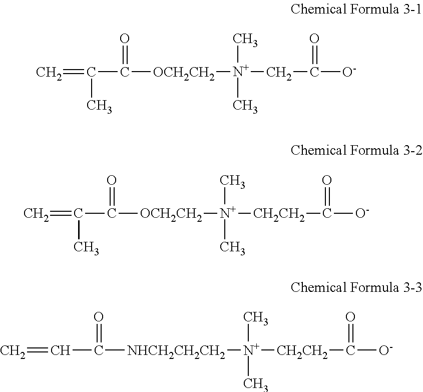

In an example embodiment, the imidazolium monomer may be or include a compound represented by Chemical Formula 4 below.

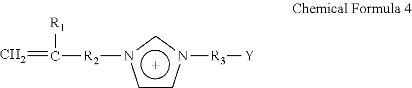

In Chemical Formula 4, R₁ may be hydrogen or a methyl group.
R₂ and R₃ may each independently be or include a single bond, a C1 to C10 alkylene group, a C6 to C10 arylene group, or a C7 to C10 arylalkylene group.
Y may be or include carboxylate (CO₂⁻), sulfonate (SO₃⁻), or phosphate ester (PO₄⁻). The alkylene group, the arylene group, the arylalkylene group, and the alkyl group may each be substituted or unsubstituted.

For example, the imidazolium monomer may include one or more compounds represented by Chemical Formulae 4-1 to 4-4 below.

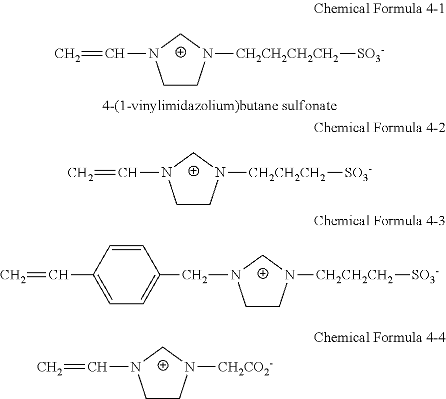

In an example embodiment, the third monomer may include one or more compounds, each, or at least one, of which includes a zwitterionic monomer, represented by Chemical Formulae 5-1 to 5-19 below.

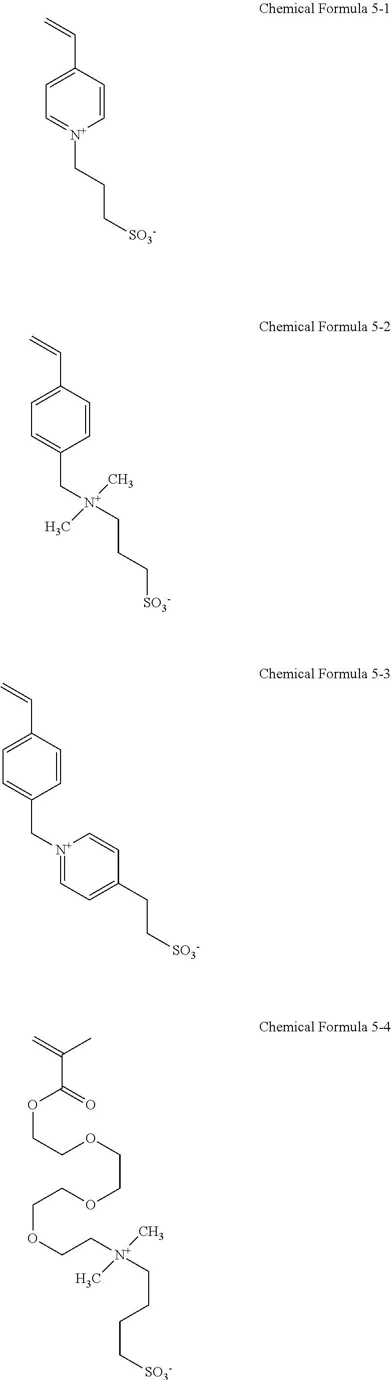

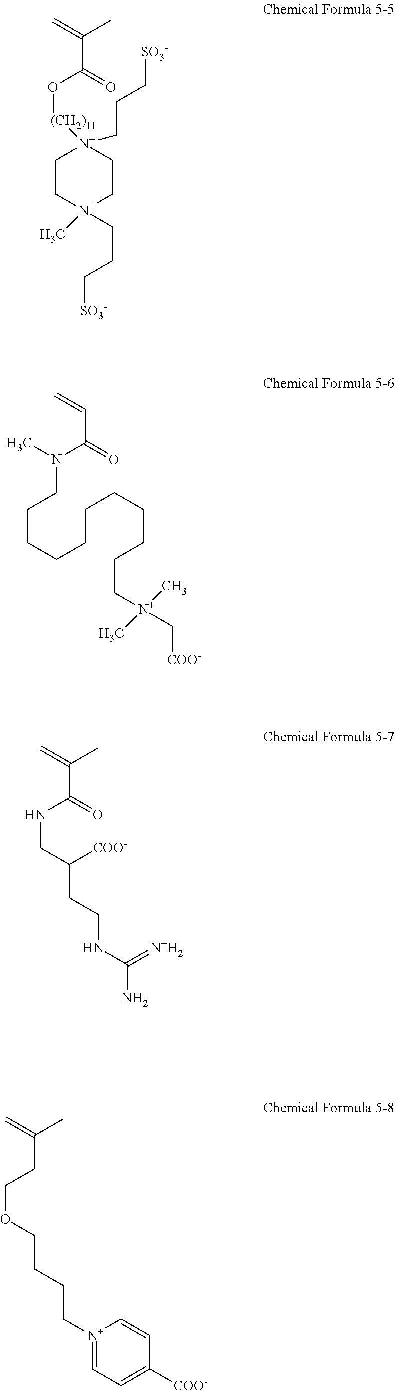

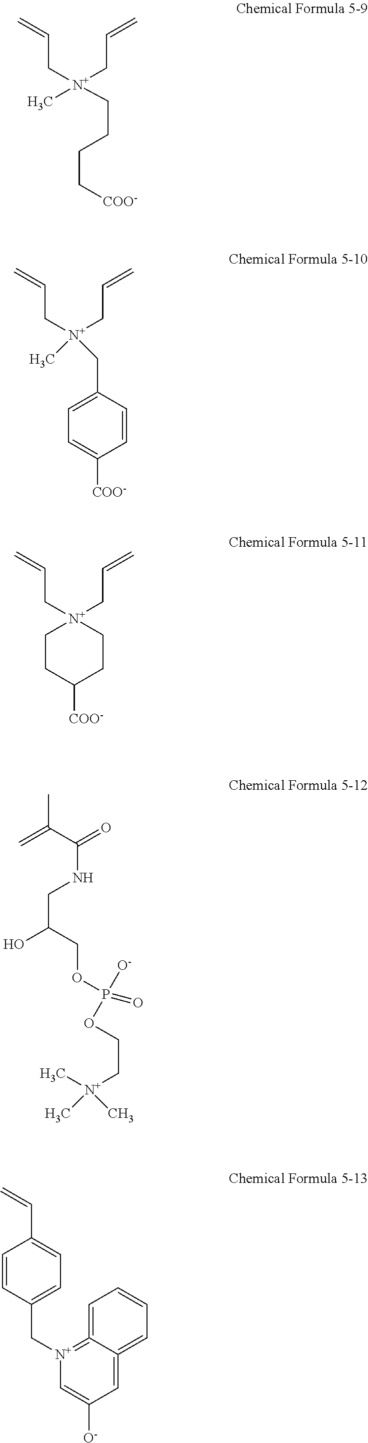

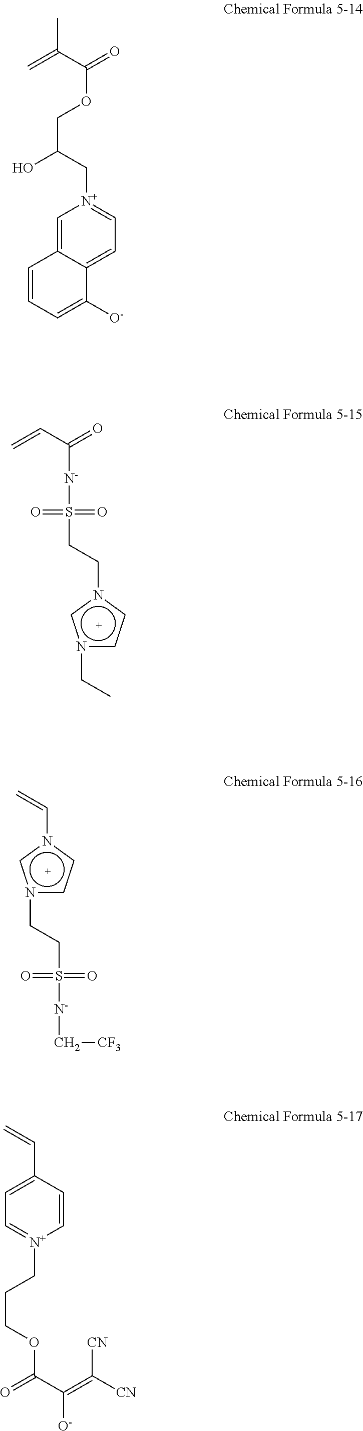

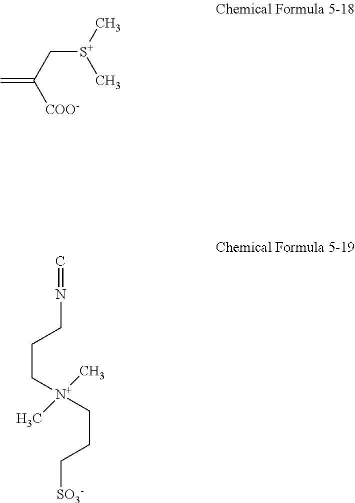

The conductive binder CBD may provide viscosity to an active material slurry. In an example embodiment, an aqueous solution that includes the conductive binder CBD having an amount of about 4 wt % to about 15 wt % may have a viscosity of about 450 cps to about 6,500 cps, for example, about 1,000 cps to about 5,000 cps. A rheometer may be used to measure the viscosity at about 25° C.

The conductive binder CBD may further include a lithium salt. For example, the lithium salt may be bonded to a zwitterionic functional group of the conductive binder CBD. The lithium salt may be or include the lithium salt discussed with reference to FIG. 1, such as at least one of LiCl, LiPF₆, LiTFSI, LIFSI, LiBF₄, or LiClO₄.

In an example embodiment, an overall ratio of the first, second, and third monomers included in the conductive binder CBD may be equal to or greater than about 99.5 wt %. For example, the overall ratio may range from about 99.5 wt % to about 99.9 wt %.

In an example embodiment, a weight average molecular weight (M_{w}) of the conductive binder CBD may range from about 20,000 g/mol to about 1,500,000 g/mol. The weight average molecular weight may be measured as a polystyrene-equivalent value by gel permeation chromatography.

The conductive binder CBD may be prepared by polymerizing the first to third monomers discussed above. The polymerization may be performed by a typical method known to those skilled in the art, for example, emulsion polymerization, suspension polymerization, or solution polymerization.

In an example embodiment, the conductive binder CBD may be prepared by emulsion polymerization. For example, a monomer mixture including the first to third monomers, an emulsifier, and an initiator may be mixed in a solvent, and heat or light may be applied to prepare the conductive binder CBD.

The emulsifier may be or include at least one of long-chain fatty acid alkali salt, N-acrylamino acid salt, alkyl ether carboxylic acid salt, acylated peptide, alkyl sulfonate, alkylbenzene sulfonate, alkyl amino acid salt, alkyl naphthalene sulfonate, sulfosuccinate, sulfated oil, alkyl sulfate, alkyl ether sulfate, alkyl aryl ether sulfate, alkyl amide sulfate, alkyl phosphate, alkyl ether phosphate, alkyl aryl ether phosphate, and any combination thereof. The alkyl group may be or include a C1 to C20 alkyl group. The emulsifier may be or include, for example, sodium dodecylbenzene sulfonate.

The emulsifier may be added in an amount of about 0.1 parts by weight to about 3 parts by weight or about 0.1 parts by weight to about 2 parts by weight relative to the total 100 parts by weight of the monomer mixture. As the emulsifier is added within any of the above ranges, it may be possible to obtain a conductive binder CBD that has an appropriate size and adhesive force.

The initiator may be or include at least one of an azo compound initiator (e.g., azobisisobutyronitrile), ammonium persulfate, potassium persulfate, hydrogen peroxide, t-butyl hydroperoxide, and any combination thereof.

The initiator may be included in an amount of about 0.1 parts by weight to about 3 parts by weight or about 0.1 parts by weight to about 2 parts by weight relative to the total 100 parts by weight of the monomer mixture.

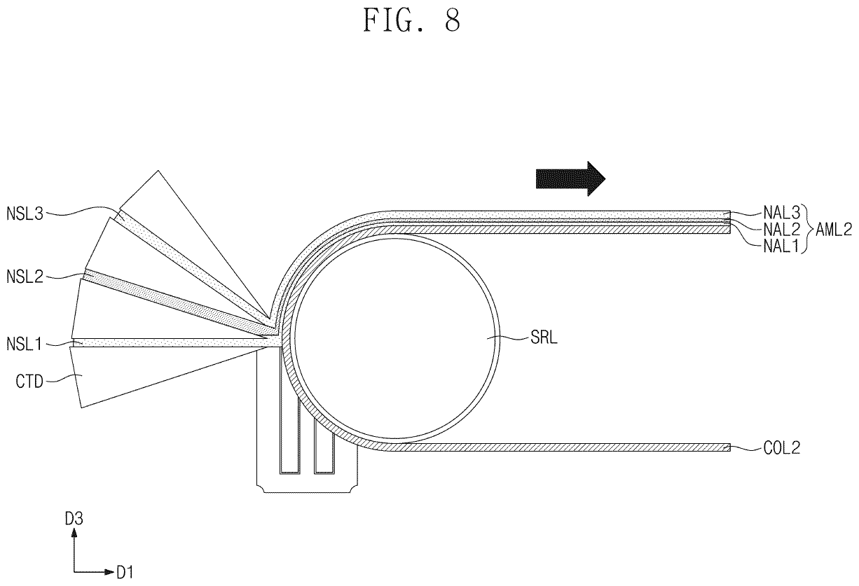

FIG. 8 illustrates a cross-sectional view showing a method of manufacturing a negative electrode, according to an example embodiment of the present disclosure.

Referring to FIG. 8, a wound negative electrode current collector COL2 may be unwrapped and fed into a coating process. The traveling negative electrode current collector COL2 may be transported and coated in a first direction D1 by a supporting roll SRL rotating in a clockwise direction. On the supporting roll SRL, the negative electrode current collector COL2 may undergo a coating process.

A coating die CTD may be adjacent to the supporting roll SRL. The coating die CTD may include three holes for slurry injection. The three slurry injection holes may be respectively provided with a first negative electrode slurry NSL1, a second negative electrode slurry NSL2, and a third negative electrode slurry NSL3. Although three holes are illustrated in FIG. 8, there may be more, or less, than three holes in other examples of the disclosure.

For example, the first negative electrode slurry NSL1 may include a first crystalline carbon CRC1, a first functional additive FUA1, and a solvent. The first functional additive FUA1 may include a first binder BND1 and further include a first conductive material CDM1. The first binder BND1 may include an aqueous binder and a thickener. The second negative electrode slurry NSL2 may include a second crystalline carbon CRC2, a silicon-containing particle SCP, a second functional additive FUA2, and a solvent. The second functional additive FUA2 may include a second binder BND2 and a conductive binder CBD. The second functional additive FUA2 may further include a second conductive material CDM2. The third negative electrode slurry NSL3 may include a third crystalline carbon CRC3, a third functional additive FUA3, and a solvent. The third functional additive FUA3 may include a third binder BND3 and further include a third conductive material CDM3. The third binder BND3 may include an aqueous binder and a thickener.

Each, or at least one, of the first to third crystalline carbons CRC1 to CRC3 may be or include natural graphite, artificial graphite, or any mixture thereof. For example, the first negative electrode slurry NSL1 may include natural graphite. The third negative electrode slurry NSL3 may include artificial graphite. Each, or at least one, of the first to third functional additives FUA1 to FUA3 may further include a conductive material.

The coating die CTD may be configured to coat, e.g., to sequentially coat, at least one of the first negative electrode slurry NSL1, the second negative electrode slurry NSL2, and the third negative electrode slurry NSL3, on the negative electrode current collector COL2.

The solvent in the slurry may be or include a typically used solvent in the art, and for example, may include at least one of dimethyl sulfoxide (DMSO), isopropyl alcohol, N-methyl pyrrolidone (NMP), acetone, water, and any combination thereof.

The first negative electrode slurry NSL1, the second negative electrode slurry NSL2, and the third negative electrode slurry NSL3 coated on the negative electrode current collector COL2 may be dried to respectively form a first active material layer NAL1, a second active material layer NAL2, and a third active material layer NAL3 that are discussed above with reference to FIG. 6. A negative electrode active material layer AML2 may be constituted by the first active material layer NAL1, the second active material layer NAL2, and the third active material layer NAL3 that are stacked, e.g., sequentially stacked, on the negative electrode current collector COL2.

Afterwards, the negative electrode 20 may undergo, e.g., sequentially undergo, at least one of a roll pressing process, a slitting process, and a notching process. The negative electrode 20, a separator 30, and a positive electrode 10 may be stacked, and then an electrolyte ELL may be provided to fabricate a rechargeable lithium battery according to the present disclosure.

The following description will focus on some example embodiments of the present disclosure. The following example embodiments are provided to aid in understanding of the present disclosure and are not intended to limit the scope of the present disclosure.

### Preparation Example

### Preparation of Silicon-Carbon Composite

Crystalline carbon (e.g., graphite, GNs, soft carbon), nano-Si (D₅₀: 100 nm) crushed for 10 to 20 hours in a Beads Mill (commercially available from NETZSCH), and amorphous carbon (e.g., pitch, resin, hydrocarbon, and the like) were mixed in a weight ratio of 40:40:20, and a homogenizer was subsequently used to uniformly disperse the mixture in a solvent (e.g., IPA, ETOH, and the like). The dispersed mixture was spray-dried at a temperature of 50° C. to 100° C. with a spray dryer, and thermally treated at a temperature of 900° C. to 1,000° C. in an N₂ furnace to coat amorphous carbon. Subsequently, crushing and sieving with a 400 mesh were used to eventually obtain a silicon-carbon composite with an amorphous carbon coating layer.

### Conductive Binder

A conductive binder was prepared as follows and its characteristics were evaluated.

### Preparation 1

Based on the total 100 wt %, 100 parts by weight of a monomer mixture containing 45 wt % of acrylic acid (AA), 40 wt % of acrylonitrile (AN), and 15 wt % of sulfobetaine (SB, a compound of Chemical Formula 1-1) was mixed with an azo compound initiator and water. The initiator was used in an amount of 0.2 parts by weight relative to 100 parts by weight of the mixture.

The obtained mixture was subjected to emulsion polymerization to prepare an aqueous binder solution that includes a unit derived from acrylic acid, a unit derived from acrylonitrile, and a unit derived from sulfobetaine.

### Preparation 2

An aqueous binder solution was prepared in the same method as in Preparation 1, with a difference that 45 wt % of acrylic acid, 40 wt % of acrylamide (AM), and 15 wt % of sulfobetaine were used relative to the total 100 wt % of the monomer mixture.

### Preparation 3

A binder solution was prepared in the same method as in Preparation 1, with a difference that 45 wt % of acrylic acid, 40 wt % of acrylonitrile, and 15 wt % of 4-(1-vinylimidazolium) butane sulfonate (IMS, a compound of Chemical Formula 4-1) were used relative to the total 100 wt % of the monomer mixture.

### Preparation 4

A binder solution was prepared in the same method as in Preparation 1, with a difference that 45 wt % of acrylic acid, 40 wt % of acrylamide, and 15 wt % of 4-(1-vinylimidazolium) butane sulfonate were used relative to the total 100 wt % the monomer mixture.

### Preparations 5 to 10

A binder solution was prepared in the same method as in Preparation 1, with a difference that amounts of acrylic acid, acrylonitrile, and sulfobetaine were changed, as shown in Table 1 below, relative to the total 100 wt % of the monomer mixture.

### Preparations 11 to 16

A binder solution was prepared in the same method as in Preparation 1, with a difference that amounts of acrylic acid, acrylonitrile, sulfobetaine, and 4-(1-vinylimidazolium) butane sulfonate were changed, as shown in Table 1 below, relative to the total 100 wt % of the monomer mixture.

TABLE 1

| | | Solid substance | Viscosity |
|---|---|---|---|
| | Composition ratio | in binder | of binder |
| | of monomer | solution | solution |
| | (wt %) | (wt %) | (cPs) |
| Preparation 1 | AA:AN:SB = 45:40:15 | 10.4 | 2447 |
| Preparation 2 | AA:AM:SB = 45:40:15 | 9.4 | 2105 |
| Preparation 3 | AA:AN:IMS = 45:40:15 | 10.5 | 1354 |
| Preparation 4 | AA:AM:IMS = 45:40:15 | 11.4 | 1530 |
| Preparation 5 | AA:AN:SB = 50:48:2 | 8.5 | 5210 |
| Preparation 6 | AA:AN:SB = 45:45:10 | 9.1 | 4325 |
| Preparation 7 | AA:AN:SB = 47:43:10 | 10.5 | 2132 |
| Preparation 8 | AA:AN:SB = 40:35:25 | 12.4 | 1540 |
| Preparation 9 | AA:AN:SB = 32.5:32.5:35 | 13.2 | 1143 |
| Preparation 10 | AA:AN:SB = 27.5:27.5:45 | 12.1 | 580 |
| Preparation 11 | SB alone | insoluble | — |
| Preparation 12 | IMS alone | 15.2 | 442 |
| Preparation 13 | AN:SB = 50:50 | insoluble | — |
| Preparation 14 | AN:IMS = 50:50 | insoluble | — |
| Preparation 15 | AA:SB = 50:50 | 4.2 | 120 |
| Preparation 16 | AA:IMS = 50:50 | 5.3 | 60 |

AA: acrylic acid,
AN: acrylonitrile,
SB: sulfobetaine,
IMS: 4-(1-vinylimidazolium) butane sulfonate

As shown in Table 1, Preparations 11 and 12, in which the third monomer alone was prepared, exhibited insolubility or excessively low viscosity, thereby not being suitable for use as a conductive binder. Preparations 13 and 14, in which the first monomer was not included, exhibited insolubility, thereby not being suitable for use as a conductive binder. Preparations 15 and 16, in which the second monomer was not included, exhibited excessively low viscosity, thereby not being suitable for use as a conductive binder.

For example, the binders of Preparations 1 to 10 were estimated to be suitable for use as a conductive binder, and the conductive binder of Preparation 1 was used in other example embodiments.

### Example Embodiment 1

### Manufacture of Negative Electrode

98 wt % of natural graphite, 0.8 wt % of carboxymethyl cellulose, and 1.2 wt % of styrene-butadiene rubber were mixed in pure water to prepare a first negative electrode slurry.

44 wt % of natural graphite, 44 wt % of artificial graphite, 9 wt % of a silicon-carbon composite, 0.8 wt % of the conductive binder of Preparation 1, and 2.2 wt % of styrene-butadiene rubber were mixed in pure water to prepare a second negative electrode slurry.

98 wt % of artificial graphite, 0.8 wt % of carboxymethyl cellulose, and 1.2 wt % of styrene-butadiene rubber were mixed in pure water to prepare a third negative electrode slurry.

The first negative electrode slurry, the second negative electrode slurry, and the third negative electrode slurry were sequentially coated, on a copper current collector. Thereafter, the obtained product was dried at 80° C. and subsequently pressed to manufacture a negative electrode in which first to third active material layers were sequentially stacked, on the copper current collector.

### Fabrication of Half-Cell

The manufactured negative electrode was wound into a circular shape with a diameter of 14 mm, and subsequently, a 2032-type coin half-cell was fabricated with lithium metal as a counter electrode. An organic electrolyte was used in which 1.3M LiPF₆ was dissolved in a mixed solvent containing ethylene carbonate, diethyl carbonate, and fluoroethylene carbonate mixed in a weight ratio of 2:6:2.

### Fabrication of Full Cell

96 grams of LiNi_{0.6}Co_{0.2}Mn_{0.2}O₂ as a positive electrode active material, 2 grams of polyvinylidene fluoride, 47 grams of N-methyl pyrrolidone as a solvent, and 2 grams of carbon black as a conductive material were mixed to prepare a positive electrode slurry. A doctor blade was used to coat the positive electrode slurry on an aluminum current collector to manufacture a positive electrode. The positive electrode was dried at 135° C. for 3 hours or more, and subsequently pressed and vacuum dried.

The manufactured negative electrode, a polytetrafluoroethylene (PTFE) separator, and the positive electrode were stacked to fabricate a rechargeable lithium battery. 1.3M LiPF₆, dissolved in a mixed solvent containing ethylene carbonate (EC), ethylmethyl carbonate (EMC), and diethyl carbonate (DEC) mixed in a volume ratio of 3:5:2, was used as an electrolyte to fabricate a CR2032-type coin full-cell.

### Example Embodiment 2

A negative electrode, a half-cell, and a coin full-cell were fabricated in the same method as in Example Embodiment 1, with a difference that 43.65 wt % of natural graphite, 43.65 wt % of artificial graphite, 9 wt % of a silicon-carbon composite, 1.5 wt % of a conductive binder, and 2.2 wt % of styrene-butadiene rubber were mixed in pure water to prepare a second negative electrode slurry.

### Example Embodiment 3

A negative electrode, a half-cell, and a coin full-cell were fabricated in the same method as in Example Embodiment 1, with a difference that 44.15 wt % of natural graphite, 44.15 wt % of artificial graphite, 9 wt % of a silicon-carbon composite, 0.5 wt % of a conductive binder, and 2.2 wt % of styrene-butadiene rubber were mixed in pure water to prepare a second negative electrode slurry.

### Example Embodiment 4

A negative electrode, a half-cell, and a coin full-cell were fabricated in the same method as in Example Embodiment 1, with a difference that 42.4 wt % of natural graphite, 42.4 wt % of artificial graphite, 9 wt % of a silicon-carbon composite, 4 wt % of a conductive binder, and 2.2 wt % of styrene-butadiene rubber were mixed in pure water to prepare a second negative electrode slurry.

### Comparative Example 1

A negative electrode, a half-cell, and a coin full-cell were fabricated in the same method as in Example Embodiment 1, with a difference that carboxymethyl cellulose was used to replace a conductive binder when a second negative electrode slurry was prepared.

For example, 44 wt % of natural graphite, 44 wt % of artificial graphite, 9 wt % of a silicon-carbon composite, 0.8 wt % of carboxymethyl cellulose, and 2.2 wt % of styrene-butadiene rubber were mixed in pure water to prepare a second negative electrode slurry.

### Comparative Example 2

A negative electrode, a half-cell, and a coin full-cell were fabricated in the same method as in Example Embodiment 1, with a difference that 44.2 wt % of natural graphite, 44.2 wt % of artificial graphite, 9 wt % of a silicon-carbon composite, 0.4 wt % of a conductive binder, and 2.2 wt % of styrene-butadiene rubber were mixed in pure water to prepare a second negative electrode slurry.

### Comparative Example 3

A negative electrode, a half-cell, and a coin full-cell were fabricated in the same method as in Example Embodiment 1, with a difference that 42.15 wt % of natural graphite, 42.15 wt % of artificial graphite, 9 wt % of a silicon-carbon composite, 4.5 wt % of a conductive binder, and 2.2 wt % of styrene-butadiene rubber were mixed in pure water to prepare a second negative electrode slurry.

### Comparative Example 4

A negative electrode, a half-cell, and a coin full-cell were fabricated in the same method as in Example Embodiment 1, with a difference that 41.9 wt % of natural graphite, 41.9 wt % of artificial graphite, 9 wt % of a silicon-carbon composite, 5 wt % of a conductive binder, and 2.2 wt % of styrene-butadiene rubber were mixed in pure water to prepare a second negative electrode slurry.

### Comparative Example 5

A negative electrode, a half-cell, and a coin full-cell were fabricated in the same method as in Example Embodiment 1, with a difference that a conductive binder was used to replace carboxymethyl cellulose when a first negative electrode slurry was prepared and that carboxymethyl cellulose was used to replace a conductive binder when a second negative electrode slurry was prepared.

For example, 98 wt % of natural graphite, 0.8 wt % of the conductive binder of Preparation 1, and 1.2 wt % of styrene-butadiene rubber were mixed in pure water to prepare a first negative electrode slurry.

44 wt % of natural graphite, 44 wt % of artificial graphite, 9 wt % of a silicon-carbon composite, 0.8 wt % of carboxymethyl cellulose, and 2.2 wt % of styrene-butadiene rubber were mixed in pure water to prepare a second negative electrode slurry.

For example, a negative electrode, a half-cell, and a coin full-cell were fabricated such that a conductive binder was included in the first active material layer but not in the second active material layer.

Table 2 lists an amount of the conductive binder used when the second negative electrode slurry was prepared.

TABLE 2

| Category | Conductive binder (wt %) |
|---|---|
| Example Embodiment 1 | 0.8 |
| Example Embodiment 2 | 1.5 |
| Example Embodiment 3 | 0.5 |
| Example Embodiment 4 | 4 |
| Comparative Example 1 | −(0.8% of carboxyl cellulose) |
| Comparative Example 2 | 0.4 |
| Comparative Example 3 | 4.5 |
| Comparative Example 4 | 5 |
| Comparative Example 5 | −(0.8% of carboxyl cellulose) |

### Evaluation 1: Specific Capacity Characteristics of Half-Cells and Rapid Charge Characteristics of Rechargeable Lithium Batteries

The coin half-cells using the negative electrodes according to Example Embodiments 1 to 4 and Comparative Examples 1 to 4 were 0.2 C, 0.01 V cut-off charged under the condition of constant current, 0.05 C cut-off charged under the condition of constant voltage, and 0.2 C, 1.5 V cut-off discharged under the condition of constant current. A discharge capacity at the first charge/discharge was obtained to evaluate specific capacity characteristics of the half-cell, and the results are listed in Table 3 below.

The coin full-cells using the negative electrodes according to Example Embodiments 1 to 4 and Comparative Examples 1 to 5 were charged and discharged one time in which 0.2 C, 4.4 V cut-off charged under the condition of constant current, 0.05 C cut-off charged under the condition of constant voltage, and 2.45 V cut-off discharged under the condition of constant current, and subsequently charged for 30 minutes at 2.0 C, 4.4 V cut-off under the condition of constant current and 0.05 C cut-off under the condition of constant voltage. Thereafter, the coin full-cells were 0.2 C, 3.0 V cut-off discharged under the condition of constant current. From the measurement results, a ratio of the charge capacity at the second charge/discharge to the charge capacity at the first charge/discharge was calculated to obtain a 30-minute rapid charge rate (%), and the results are listed in Table 3 below.

TABLE 3

| | Amount of | | 30-minute rapid |
|---|---|---|---|
| | conductive | Specific capacity | charge rate |
| | binder in | (0.2 C, discharge | (2^{nd} charge |
| | second negative | capacity at first | capacity/1^{st} |
| | electrode slurry | charge/discharge) | charge capacity) |
| | (wt %) | (mAh/g) | (%) |
| Example | 0.8 | 350 | 82.5 |
| Embodiment 1 | | | |
| Example | 1.5 | 335 | 83.4 |
| Embodiment 2 | | | |
| Example | 0.5 | 352 | 80.2 |
| Embodiment 3 | | | |
| Example | 4 | 310 | 82.8 |
| Embodiment 4 | | | |
| Comparative | −(0.8% of | 302 | 71.8 |
| Example 1 | carboxyl | | |
| | cellulose) | | |
| Comparative | 0.4 | 305 | 78 |
| Example 2 | | | |
| Comparative | 4.5 | 298 | 79 |
| Example 3 | | | |
| Comparative | 5 | 280 | 75 |
| Example 4 | | | |
| Comparative | −(0.8% of | 304 | 72.3 |
| Example 5 | carboxyl | | |
| | cellulose) | | |

Referring to Table 3, the negative electrode of Comparative Example 1 having no conductive binder has an excessively low rapid charge rate. In addition, the negative electrode of Comparative Example 5, where the conductive binder was included in the first active material layer but not in the second active material layer, has an excessively low rapid charge rate.

The negative electrode of Comparative Example 2 has a relatively low amount of the conductive binder and a reduced rapid charge rate. The negative electrode of Comparative Examples 3 and 4 having a relatively high amount of the conductive binder has an excessively low specific capacity and a reduced rapid charge rate. A relatively large increase in amount of the conductive binder causes an increase in ion conductivity and a reduction in electron conductivity.

In contrast, each of the negative electrodes of Example Embodiments 1 to 4 where the conductive binder in the second negative electrode slurry has an amount of 0.5 wt % to 4 wt % has a desired or improved specific capacity that is equal to or greater than 300 mAh/g, and a desired or improved rapid charge rate that is equal to or greater than 80%. In conclusion, the presence of an appropriate amount of the conductive binder in the second active material layer containing silicon may achieve a negative electrode having desired or improved specific capacity and rapid charge rate.

In a negative electrode for a rechargeable lithium battery according to the present disclosure, a silicon-containing active material layer may be disposed between silicon-free active material layers to mitigate a volume change of the silicon-containing active material layer. In addition, an ion conductive binder may be disposed on the silicon-containing active material layer to secure an ion delivery pathway, which may result in an increase in ion conductivity. As a result, a rechargeable lithium battery according to the present disclosure may have desired or improved capacity and charge/discharge rate.

While this disclosure has been described in connection with what is presently considered to be example embodiments, it is to be understood that the present disclosure is not limited to the disclosed example embodiments and is intended to cover various modifications and equivalent arrangements included within the spirit and scope of the appended claims, and therefore the aforementioned example embodiments should be understood to be examples but not limiting this disclosure in any way.

What is claimed is:

1. A negative electrode for a rechargeable lithium battery, the negative electrode comprising:
a negative electrode current collector; and
a negative electrode active material layer on the negative electrode current collector,
wherein the negative electrode active material layer includes:
a first active material layer;
a second active material layer; and
a third active material layer, the first active material layer, the second active material layer and the third active material layer being stacked on the negative electrode current collector,
wherein the second active material layer includes a silicon-containing particle and a conductive binder,
wherein the conductive binder includes a unit derived from a first monomer, a unit derived from a second monomer, and a unit derived from a third monomer,
wherein at least one of the first monomer and the second monomer is a (meth)acrylate monomer, and
wherein the third monomer is a zwitterionic monomer.

2. The negative electrode of claim 1, wherein:
the first monomer comprises a (meth)acryl monomer having a carboxylic acid group or a carboxylic acid metal salt; and
the second monomer comprises a (meth)acrylic monomer having an amide group or a nitrile group.

3. The negative electrode of claim 1, wherein the third monomer comprises one or more of a zwitterionic vinyl monomer and a zwitterionic (meth)acryl monomer.

4. The negative electrode of claim 3, wherein:
the zwitterionic vinyl monomer comprises an imidazolium monomer, and
the zwitterionic (meth)acryl monomer comprises at least one of sulfobetaine monomer, a phosphobetaine monomer, and a carboxybetaine monomer.

5. The negative electrode of claim 1, wherein the unit derived from the third monomer in the conductive binder has a ratio of about 2 wt % to about 45 wt %.

6. The negative electrode of claim 1, wherein the conductive binder further comprises a lithium salt.

7. The negative electrode of claim 1, wherein the second active material layer comprises the conductive binder in an amount of about 0.5 wt % to about 4 wt %.

8. The negative electrode of claim 1, wherein:
the first active material layer comprises a first crystalline carbon,
the second active material layer comprises a second crystalline carbon,
the third active material layer comprises a third crystalline carbon, and
at least one of the first, second, and third crystalline carbons comprises at least one of artificial graphite and natural graphite.

9. The negative electrode of claim 8, wherein:
a ratio of the natural graphite in the first crystalline carbon is greater than a ratio of the artificial graphite in the first crystalline carbon, and
a ratio of the artificial graphite in the third crystalline carbon is greater than a ratio of the natural graphite in the third crystalline carbon.

10. The negative electrode of claim 1, wherein the silicon-containing particle comprises at least one of silicon, a silicon-carbon composite, silicon oxide, and a Si-Q alloy;
wherein Q comprises at least one of alkali metal, alkaline earth metal, a Group 13 element, a Group 14 element except for Si, a Group 15 element, a Group 16 element, transition metal, and a rare-earth element.

11. The negative electrode of claim 1, wherein the second active material layer comprises silicon in an amount of about 5 wt % to about 30 wt %.

12. A negative electrode for a rechargeable lithium battery, the negative electrode comprising:
a negative electrode current collector; and
a negative electrode active material layer on the negative electrode current collector;
wherein the negative electrode active material layer comprises at least one of crystalline carbon, a silicon-containing particle, and a conductive binder;
wherein the negative electrode active material layer has:
a first region adjacent to the negative electrode current collector;
a third region adjacent to a top surface of the negative electrode active material layer; and
a second region on a center of the negative electrode active material layer;
wherein the second region is interposed between the first region and the third region,
wherein an amount of the silicon-containing particle in the second region is greater than an amount of the silicon-containing particle in the first region,
wherein the amount of the silicon-containing particle in the second region is greater than an amount of the silicon-containing particle in the third region,
wherein an amount of the conductive binder in the second region is greater than an amount of the conductive binder in the first region, and
wherein the amount of the conductive binder in the second region is greater than an amount of the conductive binder in the third region.

13. The negative electrode of claim 12, wherein:
the first region comprises a first binder,
the third region comprises a third binder, and
at least one of the first binder and the third binder comprises at least one of an aqueous binder and a thickener, the aqueous binder including at least one of styrene-butadiene rubber, (meth)acrylated styrene-butadiene rubber, (meth)acrylonitrile-butadiene rubber, (meth)acrylic rubber, butyl rubber, fluororubber, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, and a combination thereof.

14. The negative electrode of claim 13, wherein the thickener comprises a cellulose-based compound.

15. The negative electrode of claim 12, wherein the second region comprises a second binder, and
wherein the second binder comprises an aqueous binder including at least one of styrene-butadiene rubber, (meth)acrylated styrene-butadiene rubber, (meth)acrylonitrile-butadiene rubber, (meth)acrylic rubber, butyl rubber, fluoro elastomer, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, and a combination thereof.

16. The negative electrode of claim 12, wherein the conductive binder comprises:
a unit derived from a first monomer;
a unit derived from a second monomer; and
a unit derived from a third monomer,
wherein at least one of the first monomer and the second monomer comprises a (meth)acrylate monomer, and
wherein the third monomer comprises a zwitterionic monomer.

17. The negative electrode of claim 12, wherein the second region comprises the conductive binder in an amount of about 0.5 wt % to about 4 wt %.

18. The negative electrode of claim 12, wherein:
the crystalline carbon of the negative electrode active material layer comprises at least one of artificial graphite and natural graphite,
in the crystalline carbon of the first region, a ratio of the natural graphite is greater than a ratio of the artificial graphite, and
in the crystalline carbon of the third region, a ratio of the artificial graphite is greater than a ratio of the natural graphite.

19. The negative electrode of claim 12, wherein the second region comprises silicon in an amount of about 5 wt % to about 30 wt %.

20. A rechargeable lithium battery, comprising:
the negative electrode as set forth in claim 1;
a positive electrode that includes a positive electrode current collector, and a positive electrode active material layer on the positive electrode current collector; and
a separator between the negative electrode and the positive electrode.
